(19) United States
(12) Patent Application Publication
(10) Pub. No.: US 2005/0103944 A1
(43) Pub. Date: May 19, 2005

(54) Trailing vortex management via boundary layer separation control

(75) Inventor: David Greenblatt, Newport News, VA (US)

Correspondence Address: NATIONAL AERONAUTICS AND SPACE ADMINISTR;ATION LANGLEY RESEARCH CENTER, 3 LANGLEY BOULEVARD, MAIL STOP 212, HAMPTON, VA, 236812199, US

(73) Assignee: US of America as represented by the Administrator of the National Aeronautics & Space Administration, Washington, DC (US)

(21) Appl. No.: 10/890,842

(22) Filed: Jul. 8, 2004

Related U.S. Application Data
(60) Provisional application No. 60/487,478, filed on Jul. 11, 2003.

(51) Int. Cl. B64C 23/06

(52) U.S. Cl. 244/199

(57) ABSTRACT

A method and device utilizes boundary layer separation control for the purpose of wake vortex alleviation. Trailing vortices are manipulated by varying the spanwise vortex-sheet strength via either passive or active boundary layer separation control. Boundary layer separation can be diminished or promoted to vary vortex properties, such as locations and strengths, so as to generate wake signatures that are unstable, resulting in complex three-dimensional interaction and rapid destruction of vortex coherence in the wake. Separation control can be achieved in either a time-dependent or a time-invariant mode.

This application claims the benefit of U.S. Provisional Application No. 60/487,478, filed Jul. 11, 2003, and entitled “Vortex Management Via Separation Control.”

### ORIGIN OF THE INVENTION

The invention described herein was made by an employee of the National Research Council and may be manufactured and used by or for the government for governmental purposes without the payment of royalties thereon or therefor.

### BACKGROUND OF THE INVENTION

1. Field of the Invention

The subject invention relates to aerodynamic controls, and relates more specifically to the management of vortices trailing aerodynamic structures.

2. Description of the Related Art

A well-known problem associated with large aircraft is that of powerful vortices (swirling flows), that trail in their wakes. An aircraft following a leading aircraft in flight may encounter or penetrate the vortices of the leading aircraft and may experience severe upward or downward loads or overpowering rolling moments, depending on their size, and their location and relative orientation of the penetrating aircraft with respect to the vortices. Consequently, a severe and potentially catastrophic aerodynamic hazard is posed when the vortices are strong enough to cause an encountering aircraft to lose control. Several accidents have been attributed to these vortices, also referred to loosely as wake turbulence, in recent decades.

Over time, vortices may decay, burst, or destroy each other. However, in the vicinity of airports, they are usually slowly transported away by self-induction or by atmospheric currents. Consequently, the wake hazard constrains aircraft to specific flight “corridors” for approach and landing as well as to specific runways for takeoff. Furthermore, due to persistence of the vortices, following aircraft are required to delay their arrival until the vortices are out of the flight corridor or have decayed sufficiently. To facilitate this, regulatory instrument and visual flight rules have been set up to govern the minimum separation distances. Such rules are based on the relative weights of the leading and following aircraft. In many instances, the spacing stipulated due to wake vortices is larger than that dictated by other factors such as radar resolution or runway occupancy, and consequently these rules add to airport delays and congestion. This can result in a 12% loss in capacity for typical major U.S. airports and consequently significant financial losses.

A further problem associated with these vortices, particularly in the vicinity of airports, is the noise that they generate during takeoff and landing. The significant advances in jet engine design in recent years has been so successful at reducing jet-noise levels on present generation aircraft, that the vortices generated at flap edges now constitute a major source of airframe noise. Present methods aimed at alleviating noise due to vortex generation target one or other facet of the vortex, such as vortex initiation, the strength of the vortex or so-called vortex breakdown near the flap trailing edge. Proposed methods are all time-invariant fixes, such as side-edge fences or porous flap tips, as well as active blowing through the flap side-edge. None of these methods, however, are capable of fundamental modification or management of the vortices in a meaningful manner.

In the context of the hazard posed to following aircraft, a large number of wake vortex alleviation techniques have been proposed, but none are applied to commercial aircraft. Many of them employ spoilers, splines, wing-mounted fins or vortex generators in an attempt to dissipate the vortices by “turbulence injection,” but they generally produce insufficient far-field alleviation and often significantly increase drag. It is widely believed that wake instabilities, resulting in large-scale interaction of the vortices, must occur to bring about their mutual destruction and hence effective wake alleviation. The origin of this concept is based on wake instability observations that were subsequently analyzed and explained in terms of mutual induction. In order to achieve large-scale vortex interaction, and subsequent destruction, a number of time-invariant and time-dependent methods have been proposed.

Time-invariant methods rely on establishing a particular wake structure, or signature, and then allowing natural perturbations in the atmosphere to seed the instability. The rationale behind these methods is the observation that the structure of wake vortices is intimately related to the spanwise nature of the wing-loading or circulation distribution. The general approach is to establish two or more pairs of opposite-signed counter-rotating vortices and allow naturally arising instabilities to bring about linking and mutual destruction of the vortices. This can be achieved by means of differentially deflected flaps or triangular outboard flaps. In general, these methods would require extensive and expensive redesign of existing airline high-lift systems or control surfaces, which may be at the root of the industry's reluctance to embrace them.

Time-dependent methods, on the other hand, are realized for example by pitching or rolling the aircraft, but these methods are generally ruled out on the basis of passenger safety and comfort. More sophisticated methods include differentially deflecting inboard and outboard flaps or control surfaces or sloshing of the lift distribution. U.S. Pat. No. 6,082,679 to Crouch and Spalart (“Active System for Early Destruction of Trailing Vortices,” 2000) describes a method for actuating control surfaces in a manner apparently leading to the direct excitation of one or more wake instability mechanisms, including a transient growth mechanism. Presently, none of these methods have been applied to in-service aircraft. A possible difficulty associated with the Crouch and Spalart invention, however, is that the ailerons are required to maintain control authority, while simultaneously oscillating at frequencies corresponding to a wake instability. This may affect controllability, and ultimately safety, of the aircraft. Furthermore, this method adds dynamic loading to control surfaces, compromising their structural integrity. Additionally, there exists an issue of passenger acceptance, both the effect on ride quality as well as passenger response to observing the oscillation of control surfaces instead of them behaving in their traditional static manner. Finally, ailerons, spoilers, and flaps only have one mode of oscillation, namely up and down. This limits the ability of the method to effectively and efficiently excite instability modes in the wake.

To date, proposed methods for wake alleviation either do not perform satisfactorily, have limited application, may be unsafe or impractical to implement, or would require significant redesign of control systems. There is therefore a widely recognized need for a practical method for wake alleviation that is inexpensive yet effective, without necessitating a major redesign of high-lift systems or control surfaces, particularly applicable to airline aircraft applications.

### BRIEF SUMMARY OF THE INVENTION

Accordingly, it is an object of the present invention to provide a method and device for modifying wing loading, thereby producing a highly unstable wake structure that leads to rapid destruction of wake vortices. The present invention uses static or dynamic devices to control boundary layer separation, leading to modified wing loading, and in turn producing such a wake structure.

The invention can be implemented in either a time-invariant or a time-dependent mode. In its time-invariant mode, separation control devices are directly retrofit to the aircraft, resulting in minimal costs. No power is required, since the separated flows that exist over the wing elements are directly exploited by the method. Aircraft aerodynamics are not affected during cruise, because typical low profile vortex generators are tucked away in the cove of the aerodynamic structure. The invention is implemented during landing and take-off, increasing lift and improving aerodynamic quality, with no apparent associated risk. The invention is operable irrespective of weather conditions, and can be applied to high-lift systems found on different aircraft loadings (e.g. fore and aft center of gravity), as well as different airlines.

In its time-dependent mode, the present invention requires relatively small retrofits to flap elements, for example it may require internally mounted lightweight actuators or externally mounted fliperons. Like the time-invariant mode of the invention, the time-dependent mode of the invention requires low power to operate, since it exploits existing separated flow as a resource, and does not affect aircraft aerodynamics during cruise. Efficiency (L/D) of the aircraft is maintained or increased during landing and take-off with low associated risk. The separation control hardware introduces small perturbations on the span loading, compared to those produced by deflecting control surfaces. Use of the time-dependent mode of the invention allows direct excitation of different wake modes, and can impress large-amplitude forcing of vortex locations while maintaining constant lift and drag. The invention can be applied to different high-lift systems found on different aircraft, and different airlines, and can be used in different weather conditions with or without ground effect.

The present invention is a method and a device for alleviating wake vortices trailing aircraft wings, although it can be applied to any structure over which a flow passes causing trailing vortices, e.g. helicopter blades, as well as submarine and boat control planes, hulls, rudders, keels, and propellers. The invention manipulates trailing vortices by varying the spanwise wing circulation via either passive or active boundary layer separation control. Separation can be diminished or promoted to vary vortex locations and strengths, so as to generate wake signatures that are unstable, resulting in complex three-dimensional interaction and rapid destruction of vortex coherence in the wake. This is achieved by either time-invariant, or time-dependent, methods. For the time-invariant method, separation control is enforced for a significant amount of time, thereby generating trailing vortices that are susceptible to rapid destruction via natural disturbances inherent in the wake or atmosphere. For the time-dependent method, the boundary layer of air close to the surface is forced to separate and attach in a dynamic time-dependent periodic manner. The method is flexible in that it can be applied to individual vortices, and can be used to excite arbitrary wavelengths and instability modes. The present invention differs from those known in the art since it exploits flow separation for the purposes of wake alleviation.

### BRIEF DESCRIPTION OF THE SEVERAL VIEWS OF THE DRAWINGS

FIG. 1 is a planform view of a typical airliner starboard wing with flaps deployed, showing vortices trailing behind the wing.

FIG. 2 is a cross-section view through the vortices depicted in FIG. 1 corresponding to plane C-C, indicating their locations and swirling directions.

FIG. 3 is a planform view of an airliner starboard wing with flaps deployed showing the separation control devices that are used to control separation and thereby manage the vortices.

FIG. 4a is a planform view of an outboard flap showing details of the placement of separation control devices and zones where separation is controlled.

FIG. 4b is a cross-sectional view of an outboard flap, corresponding to section B-B in FIG. 4a.

FIG. 5 is a schematic of lift coefficient Cₗ as a function of angle of attack α, corresponding to the location identified as section A-A in FIG. 3, illustrating the effect separation control devices on Cₗ.

FIG. 6 is a schematic of a lift coefficient variation along the starboard wingspan for an airliner during approach for landing, illustrating the effect of separation control devices on the lift coefficient variation.

FIG. 7a is a schematic of a partial lift coefficient distribution, corresponding to the inboard section of the outboard flap (identified in FIG. 6) and showing the effect of deploying separation control devices.

FIG. 7b is a schematic of a partial lift coefficient distribution, corresponding to the outboard section of the outboard flap (identified in FIG. 6) and showing the effect of deploying separation control devices.

FIG. 7c is a depiction of the outboard flap inboard vortex location movement as a result of deploying separation control devices.

FIG. 7d is a depiction of the outboard flap outboard vortex location movement as a result of deploying separation control devices.

FIG. 8a is an illustration of experimental data showing the vortex locations and strengths in the wake of a flap where no separation control devices are deployed.

FIG. 8b is an illustration of experimental data showing the vortex locations and strengths in the wake of a flap where inboard separation control devices are actuated.

FIG. 8c is an illustration of experimental data showing the vortex locations and strengths in the wake of a flap where outboard separation control devices are actuated.

FIG. 8d is an illustration of experimental data showing the vortex locations and strengths in the wake of a flap where all separation control devices are actuated.

FIG. 8e is an illustration of experimental data showing the vortex locations and strengths in the wake of a flap where remote separation control devices are actuated.

FIG. 9 is a cross-sectional view of the wing showing the placement of separation control devices, corresponding to section A-A in FIG. 3.

FIG. 10a(i) is a top view of a vortex generator (VG) pair in its standard configuration.

FIG. 10a(ii) is a side view of a vortex generator (VG) pair in its standard configuration, corresponding to FIG. 10a(i).

FIG. 10a(iii) is a top view of a vortex generator (VG) pair rotated perpendicular to the flow direction.

FIG. 10a(iv) is a top view of a vortex generator (VG) pair rotated parallel to the flow direction.

FIG. 10b is a depiction of a dynamically deployable vortex generator.

FIG. 10c is a depiction of a dynamically deflectable Gurney flap.

FIG. 10d is a depiction of a zero net mass-flux blowing device.

FIG. 10e is a depiction of a device that can be deployed for either blowing or suction of air.

FIG. 10f is a depiction of a surface mounted flapping device.

FIG. 10g is a depiction of a surface mounted rotating device.

FIG. 11 is a cross-sectional view through the vortices depicted in FIG. 1, corresponding to plane C-C, where inner separation control devices are deployed to reduce separation and outer separation control devices are deployed to increase separation.

FIG. 12a is an illustration of experimental data showing the vortex locations measured when combinations of active and passive separation control devices are deployed.

FIG. 12b shows an example of different modes that can be excited using separation control devices.

FIG. 13a is a depiction of three different voltage signals that are used to drive an active separation control device, such as that shown in FIG. 10d, at a two frequencies, namely fₑand f_{w}.

FIG. 13b is an illustration of experimental data showing the response of upper surface pressure coefficients at different locations where f_{w}=4 Hz.

FIG. 13c is an illustration of experimental data showing the response of upper surface pressure coefficients at different locations where f_{w}=10 Hz.

FIG. 14a is an illustration of experimental data showing the maximum and minimum upper surface pressure coefficients at the wing trailing-edge for various wave-lengths of excitation λ/b.

FIG. 14b is an illustration of experimental data showing the maximum and minimum upper surface pressure coefficients at the wing leading-edge for various wave-lengths of excitation λ/b.

### DETAILED DESCRIPTION OF THE INVENTION

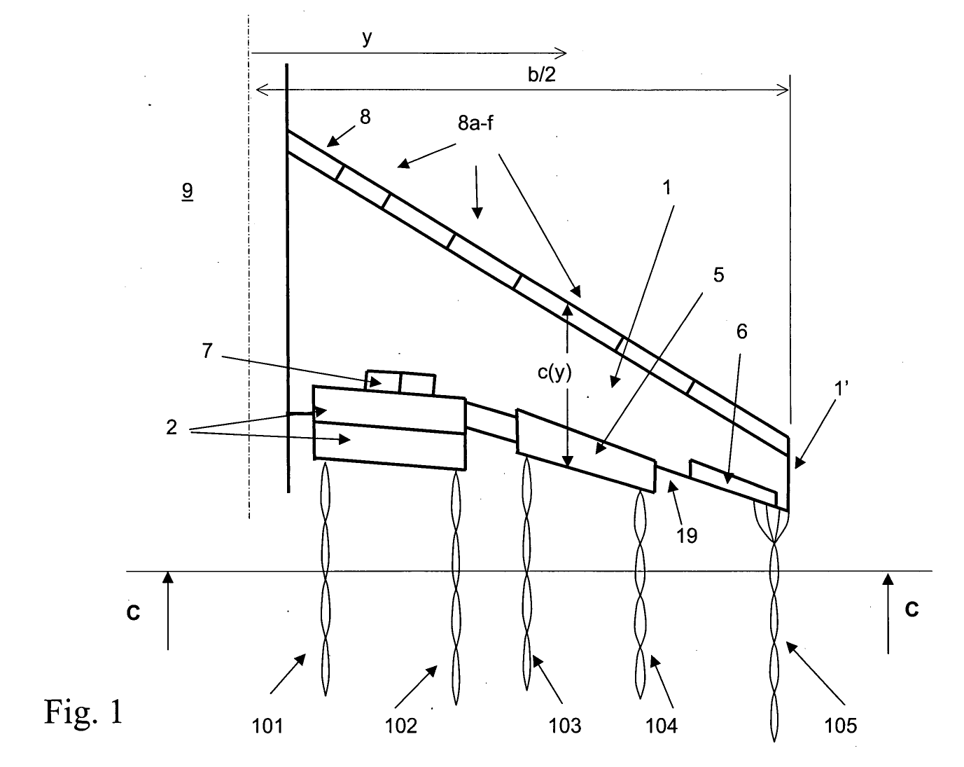

FIG. 1 depicts a typical starboard airliner wing 1 in planview. The wing includes various control surfaces, some of which serve to control the flight of the aircraft (e.g. aileron 6) and others that are used to generate high-lift for take-off and landing (e.g. inboard flap 2 and outboard flap 5). The wing 1 is attached to a fuselage 9 and in the configuration shown in FIG. 1 has its high-lift system of flaps (2 and 5) deployed. The portside wing is not shown in the figure, and is a mirror image of the starboard wing shown. The spanwise coordinate y is measured from the symmetry plane, i.e. the fuselage center. The two wings have a total wingspan denoted b; thus the starboard wing shown here has a span of b/2, and the aircraft flies at speed V. In general the lift, l(y), varies along the span y of the wing. The spanwise distance is often expressed in the non-dimensional form y/(b/2).

For purposes of clarity, it is important to introduce a number of definitions and terminology. Firstly, the local lift coefficient is defined as:

$${C}_{l} ( y ) ≡ \frac{l ( y )}{\frac{1}{2} ρ {V}^{2} c ( y )} \qquad ( 1 )$$

where ρ is the air density and c(y) is the local wing chord length. The Kutta-Joukowski theorem is defined by:
l(y)=ρVΓ(y) (2)
where Γ(y) is termed the circulation or bound vorticity. Eliminating the lift l(y) from equations (1) and (2) produces the result
Γ(y)=Cₗ(y)Vc(y)/2 (3)
The total lift on the wing 1 can hence be calculated as
L=∫₀^{b}l(y)dy (4)
and, consequently, the lift coefficient for the wing 1 is defined as:

$${C}_{L} ≡ \frac{L}{\frac{1}{2} ρ {V}^{2} s} \qquad ( 5 )$$

where S is the projected surface area of wing 1. Furthermore, the wing aspect ratio is defined as:
AR≡b/\overline{c} (6)
where \overline{c}is the standard mean chord is defined as
\overline{c}=S/b (7)
Finally, the vortex sheet strength is defined as:
γ=dΓ/dy (8)

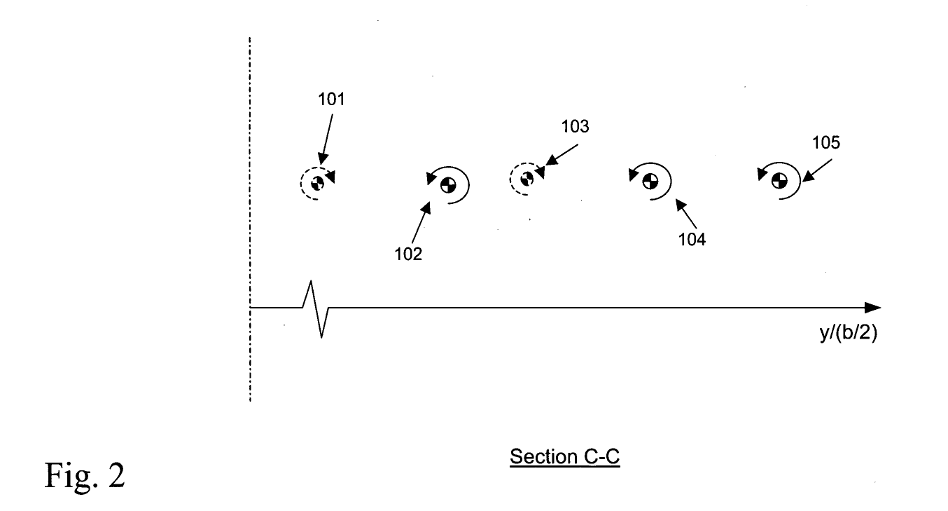

When the flaps are deployed, as shown in FIG. 1, they shed so-called trailing vortices behind the aircraft. Each flap sheds two vortices, namely an inboard vortex 101 and 103, and outboard vortex 102 and 104. A wing-tip vortex 105 is also shed from the wing-tip 1′. In general, the outboard vortices 102 and 104 are stronger than the inboard vortices 101 and 103, i.e. they have much greater swirling velocities associated with them. A cross-section through the vortices, e.g. plane C-C, is shown in FIG. 2, which indicates the swirling direction or sense of the vortices 101 to 105. This vortex structure is typical of a modern commercial airliner. As the aircraft moves in a forward direction these vortices can interact and merge with one another. It is common for the outboard flap-outboard vortex 104 to merge with the tip vortex 105, forming a single, stronger vortex.

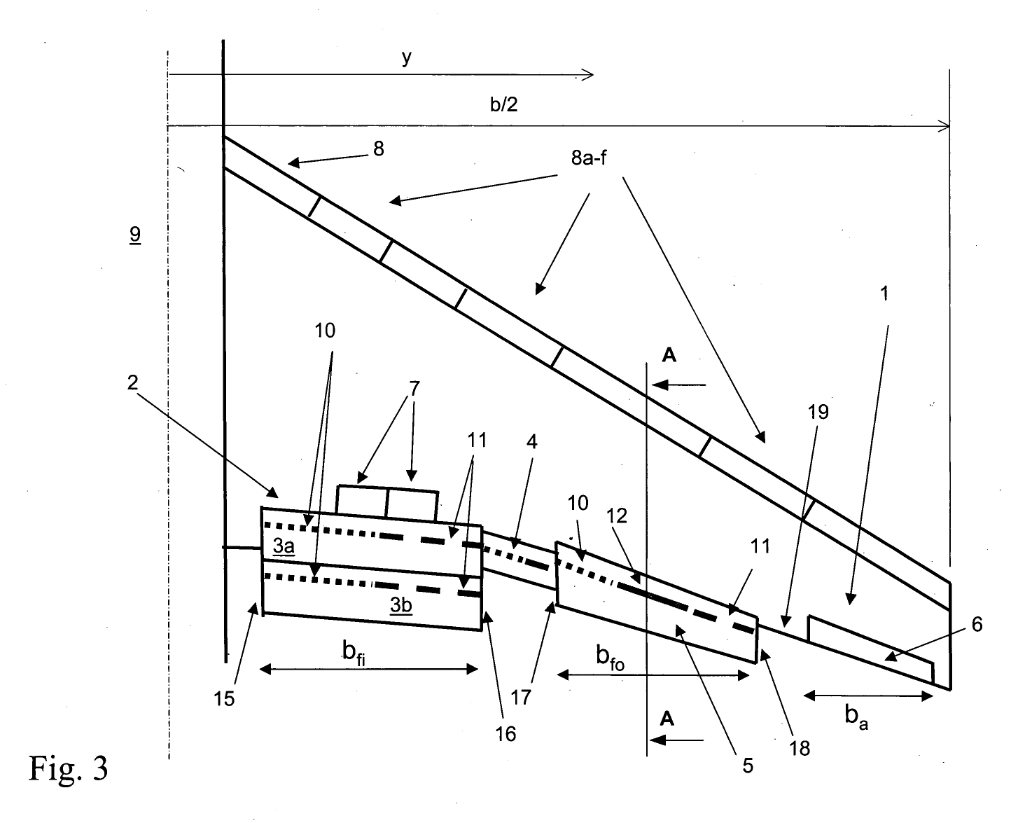

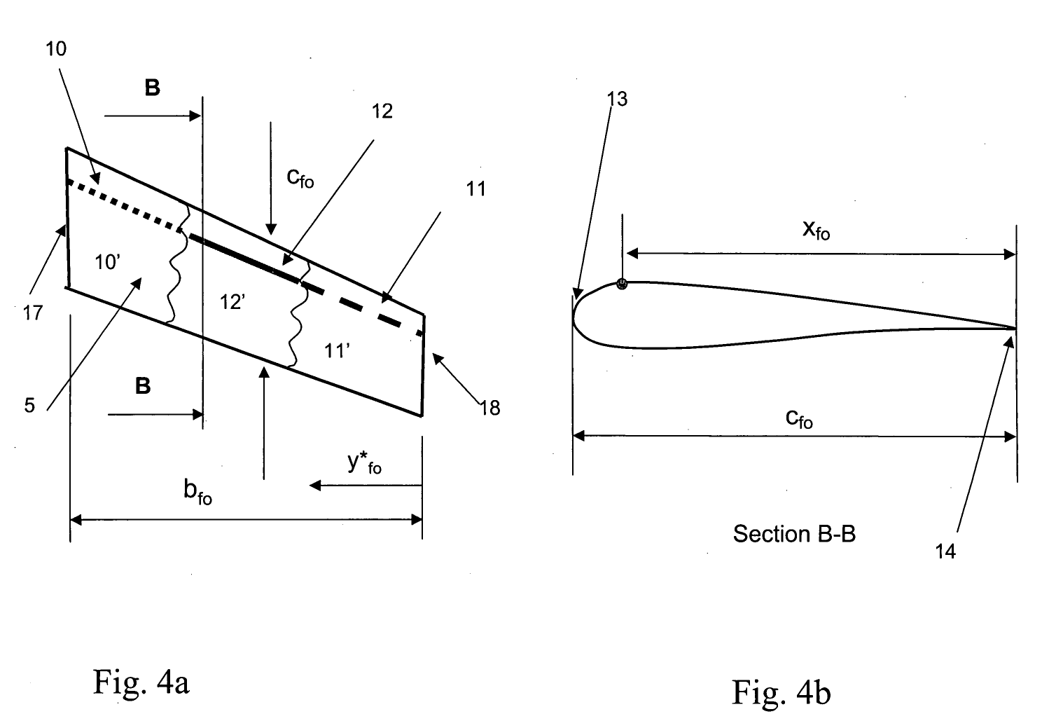

The high-lift system described here can be considered to be typical in that it contains the main elements generally associated with high-lift systems. It should be noted, however, that there is such a large variety of high-lift systems used on modern jet airliners, so there is no truly valid typical high-lift system, but the present one will suffice for the present description. With reference to FIG. 3, the aft part of the wing shown in the figure consists of an inboard flap 2, of span b_{fi} that is composed of two elements, a fore element 3a and an aft element 3b. Two elements are shown by way of example in the figure, but some aircraft (e.g. Boeing 737) have additional elements. The aft part of the wing further consists of a flaperon 4, an outboard flap 5, an aileron 6 and spoilers 7. Similarly, the flaperon 4, outboard flap 5, aileron 6 and spoilers 7 have span-lengths b_{fl}, b_{fo}, bₐ, and bₛ, respectively (see FIG. 4a). The inboard flap elements 3a and 3b have chord-lengths c_{fi(a)} and c_{fi(b)}, while the outboard flap 5, aileron 6 and spoilers 7 have chord-lengths c_{fo}, Cₐ, and cₛ, respectively. The flaperon 4 and the aileron 6 are in essence simple flaps. The leading edge 8 or front part of the wing has leading-edge devices 8a-f that also form part of the high-lift system, and the rear part of the wing is termed the trailing edge 19. For convenience, the ratio of flap chord-length to standard mean chord is defined as ξ, e.g. ξ_{fo}=c_{fo}/\overline{c}.

The layers of air between the air flowing over the wing, and the surface of the wing or its control surfaces described with respect to FIGS. 1 and 3, are termed boundary layers. Boundary layers can be attached to, separated from, or partially separated from these surfaces. When a boundary layer is attached to a surface, the flow is said to be attached to the surface. Conversely, when a boundary layer is separated or partially separated from the surface, the flow is said to be separated or partially separated from the surface, respectively. Specific to this invention are boundary layer separation control devices (SCDs) that are either passive or active (see FIG. 3). SCDs generally have much smaller dimensions than control surfaces and may consist of a single element or an array of elements. “Passive” means that the device does not require an energy source, other than the airflow over the wing, to drive it in a manner to control boundary layer separation. “Active” means that the device is driven by an energy source in a manner to control boundary layer separation, either dependently or independently of the airflow over the wing. Separation control devices are devices that (a) avoid or ameliorate separation; (b) cause or enhance separation; or (c) leave the state of the flow unaffected. Separation control devices (SCDs) can be placed arbitrarily on the high-lift system. Examples of the placement of an inner separation control device 10 (ISCD) near the inner edge 15 of the flap 2 and an outer separation control device 11 (OSCD) near the outer edge 16 of the flap 2 are shown with respect to the inboard flap 2. As a further example, the outboard flap 5 has inner and outer separation control devices 10 and 11 as well as a remote separation control device 12 (RSCD), located remotely from the inner and outer edges, 17 and 18. Similar placement of SCDs can be achieved only, 1, 4, 6, 7, and 8a-f

Traditional use of SCDs is to enhance the performance of a wing or lifting surface. In the present invention, the SCDs are used to control or manipulate the vortex sheet strength γ on wing 1 (see equation 8). It will be shown below that they are used to modify the nature of the span loading by controlling local spanwise lift distribution, and in so doing, manipulate or manage the location, strength, velocity and size of the vortices. This can be done while maintaining or varying the total lift force on the aircraft.

Further details of the outboard flap are shown in FIGS. 4a and 4b. FIG. 4a shows a planform view of flap 5, while FIG. 4b shows the cross-sectional view B-B that is indicated on FIG. 4a. Note that the coordinate y_{fo}* is measured from the outboard side of flap 5. FIG. 4a shows the separation control devices 10, 11 and 12.

Specific to the present invention is the concept of zonal separation control, where the separated flow is controlled over a certain fraction, or zone, of the flap. For example when ISCD 10 is activated, then the flow over the flap in that vicinity, namely zone 10′ is controlled. The same is true for RSCD 12 and OSCD 11, resulting in separation control in zones 12′ and 11′ respectively. If all SCDs 10, 11 and 12 are activated, then control is achieved over the entire flap. FIG. 4b illustrates the outboard flap leading-edge 13, trailing-edge 14 and local chord-length c_{fo} which, in general, varies along its span. Also defined on this figure is the local distance from the SCDs to the flap trailing edge X_{fo}. An analogous control system can be used on simple flaps and spoilers, which can be equipped in a similar manner.

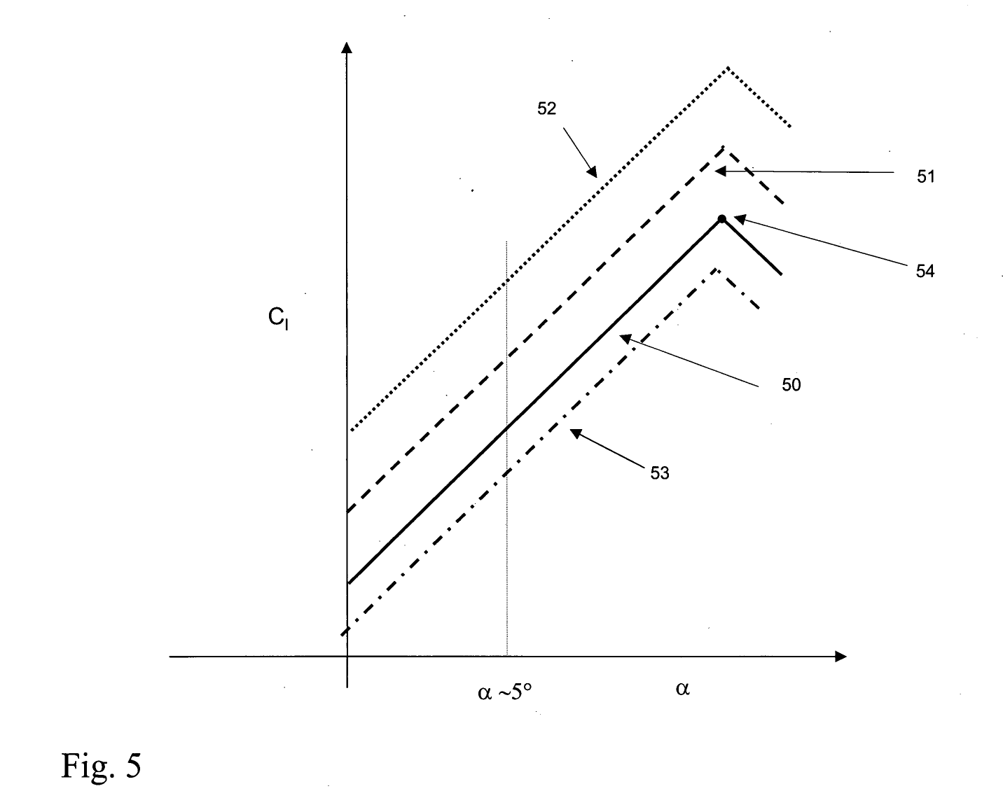

The effect of a SCD is to either enhance lift (l) by reducing or ameliorating boundary layer separation; or to diminish or reduce lift by promoting or causing boundary layer separation. This is illustrated in FIG. 5, which is a schematic showing the effect of SCDs on Cₗ as a function of angle-of-attack for a typical high-lift system. The local lift coefficient corresponding to the location identified as section A-A in FIG. 3, is taken for illustrative purposes. This is typical for a wing section on an aircraft during approach for landing. In practice, an aircraft lands at an angle-of-attack well below that corresponding to the wing C_{l,max} (indicated as 54); typically around angle-of-attack α≅5°. When the flow over the wing is not subjected to separation control, the lift approximates the result indicated by the baseline 50 in FIG. 5. This is the scenario when no separation control devices are present or the separation control devices are inactive. When passive separation control devices such as low-profile vortex generators are deployed, separation is ameliorated, and consequently the lift coefficient (or lift) at a given α increases, corresponding to the passively increased lift line 51 in FIG. 5. When active separation control devices are used to ameliorate separation, a similar but greater effect is seen, as indicated by the actively increased lift line 52 on FIG. 5. Finally, if either the passive or active separation control devices are activated or deployed to promote separation, the effect is to reduce lift, as shown by the reduced lift line 53. Since Cₗ is proportional to circulation Γ (as shown in equation 3), the vortex sheet strength γ (equation 8) can be varied locally along the span of the wing via separation control as discussed below.

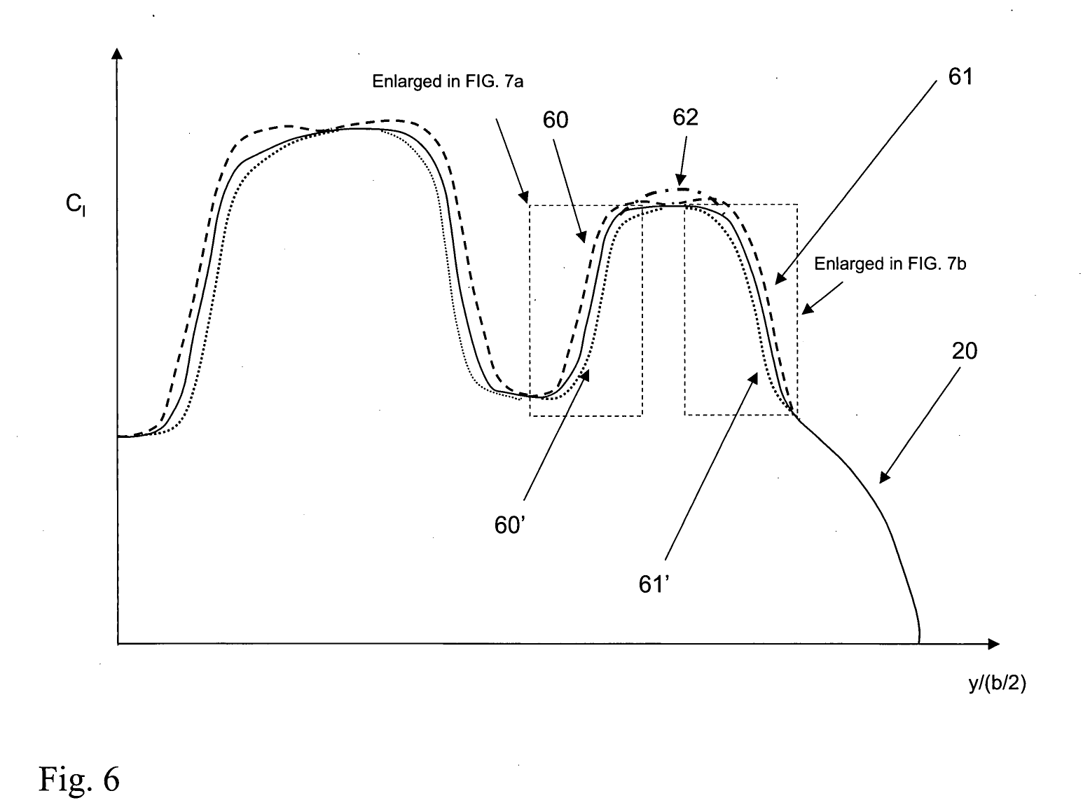

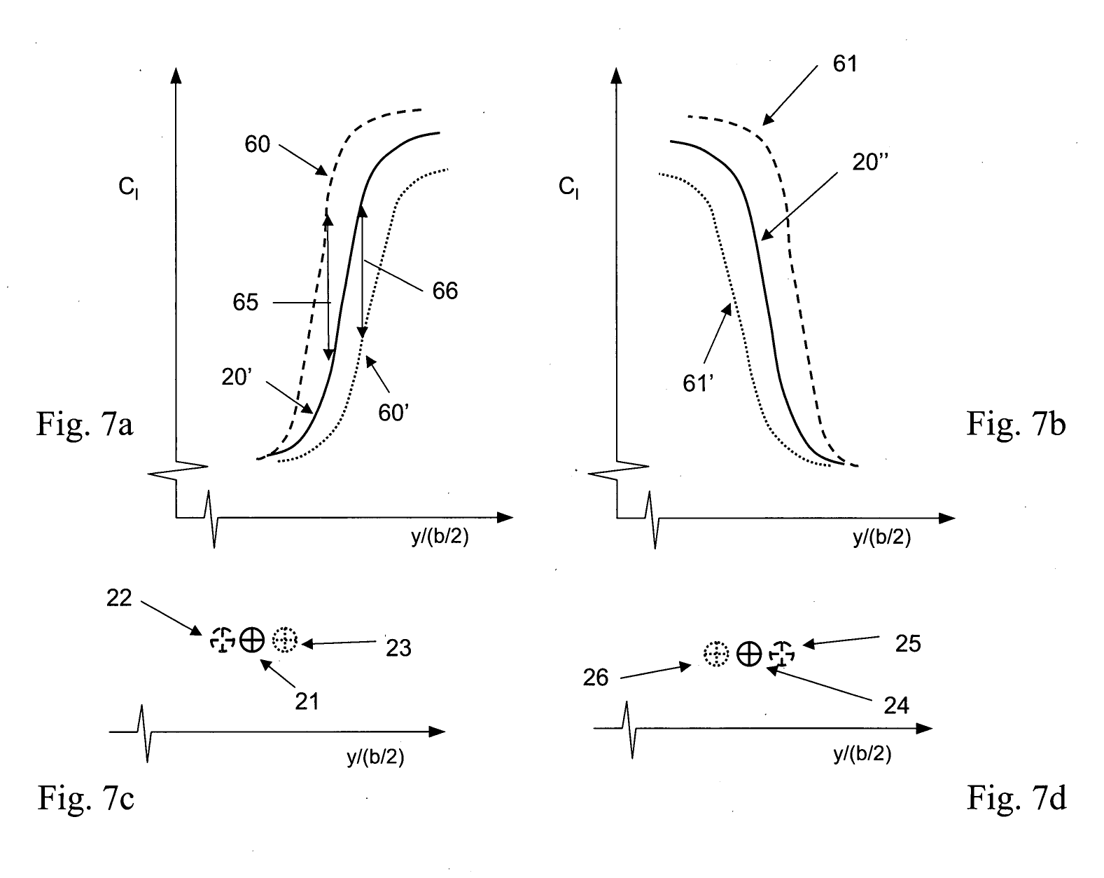

Theoretical application of the preceding discussion to vortex management as it relates to wing 1 provides the basis for the present invention, and is described below with respect to FIGS. 6, and 7a-7d. The lift distribution line 20 in FIG. 6 shows a lift coefficient distribution on the starboard wing for an airliner during approach for landing, e.g. at α≅5°. This can also be expressed as the bound vorticity distribution, Γ(y) as defined above. When separation control devices are actuated, the lift distribution is varied where changes in lift Δl are expressed as changes in lift coefficient: ΔCₗ(y)=Δl(y)/½ρV²c(y). For example, when ISCD 10 is actuated, separation can be inhibited. As a consequence, the lift coefficient in the vicinity of ISCD 10 (shown by the ISCD lift line 60) is enhanced by the amount ΔCₗ 65 (See FIG. 7a), which is generally small when compared to C_{L}. Conversely, when ISCD 10 is actuated to promote separation, lift coefficient in the vicinity of ISCD 10 (shown by the ISCD reduced lift line 60′) is reduced by the amount −ΔCₗ 66 (see FIG. 7a), which is also generally small when compared to C_{L}. Similarly, when OSCD 11 is actuated, then the lift coefficient distribution in the vicinity of OSCD 11 is varied. The SCDs 10 and 11 can be configured to generate the same ΔCₗ, but this need not be so. An enlarged view of the partial Cₗ distribution 20′ in the vicinity of ISCD 10 is shown in FIG. 7a, and corresponds to the inboard section of the outboard flap. Similarly, an enlarged view of the partial Cₗ distribution 20″ in the vicinity of OSCD 11 is shown in FIG. 7b, and corresponds to the outboard section of the outboard flap.

Also shown in the figure are vortex locations 21, 22, 23 of the resulting vortices (FIG. 7c). The locations of the vortices correspond closely to the locations where |dΓ(y)/dy| attains maximum values, i.e. where |dCₗ(y)/dy| attains maximum values. The change in the vorticity distribution caused by actuating ISCD 10, and resulting in ISCD lift line 60, causes the location of the outboard flap-inboard vortex 103 to move from baseline vortex location 21 to inboard vortex location 22, i.e. the vortex moves inboard with respect to wing 1. Conversely, when separation is diminished or ameliorated resulting in ISCD reduced lift line 60′, then the outboard flap-inboard vortex 103 moves outboard, i.e. from baseline vortex location 21 to outboard vortex location 23 with respect to the wing 1. The vortex strength, vortex velocities and vortex size can similarly be varied.

When OSCD 11 is actuated, the effect on the outboard flap-outboard vortex is similar but opposite (FIG. 7d). Namely, when separation is promoted or enhanced via OSCD 11, resulting in OSCD enhanced lift line 61, then the outboard flap-outboard vortex 104 moves outboard respect to the wing 1, i.e. from the vortex located at baseline vortex location 24 to that located at outboard vortex location 25. Conversely, when separation is diminished or ameliorated, resulting in OSCD reduced lift line 61′, then the outboard flap-outboard vortex 104 moves inboard respect to the wing 1, i.e. from the vortex located at OSCD baseline vortex location 24 to that located at OSCD inboard vortex location 26. When RSCD 12 is actuated, the lift in the central part of the flap is enhanced. This changes the strength of the vortex, but does not significantly affect the vortex locations. In addition, the change in lift, Δl or −Δl, due to actuation of ISCD 10 or OSCD 11, can be matched by actuating RSCD 12.

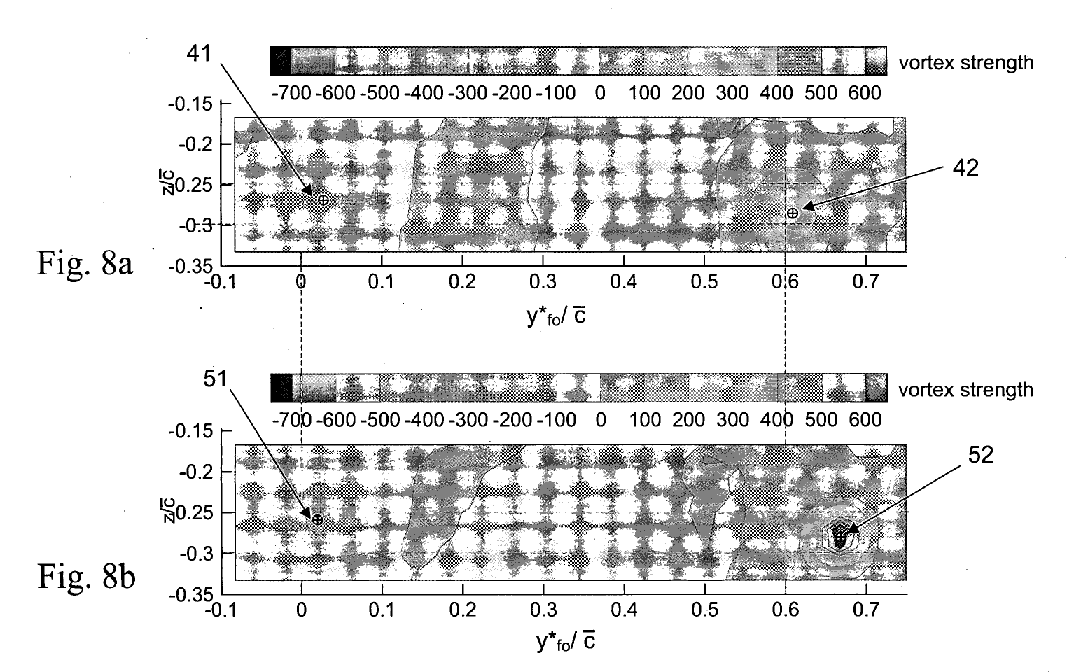

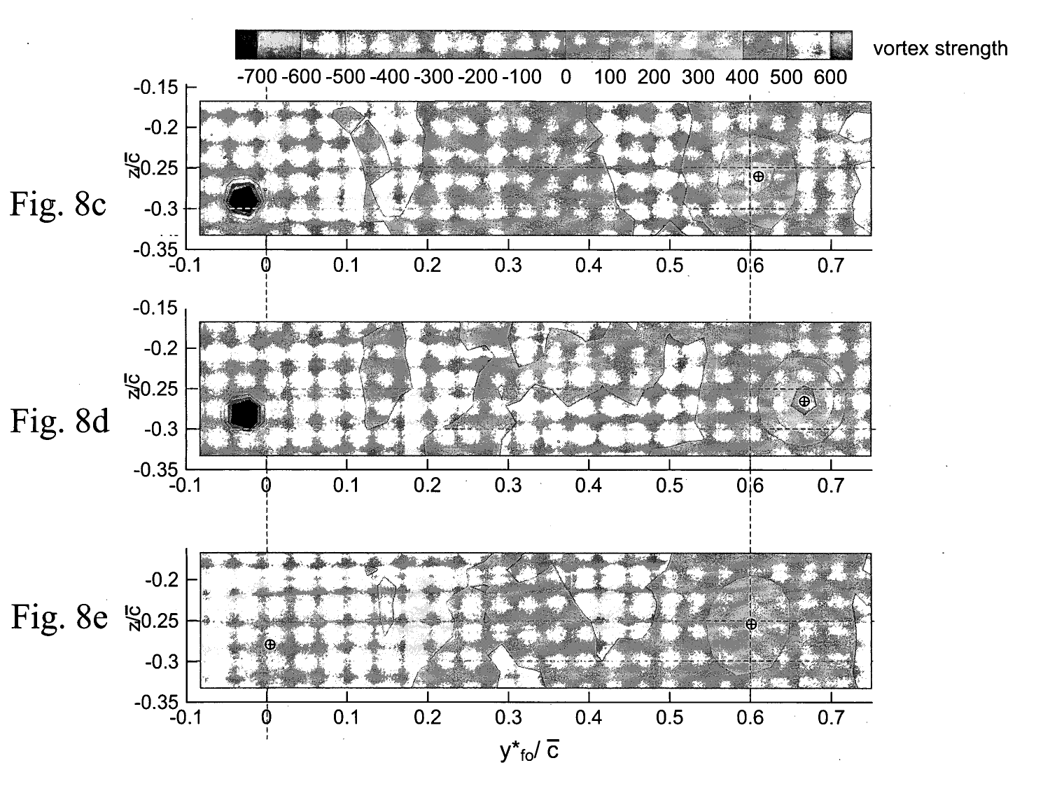

Experimental data demonstrating the vortex structure in the wake of a similar outboard flap is depicted in FIGS. 8a-8e, where the coordinate y_{fo}* is defined in FIG. 4a and z is measured perpendicular to the planform view shown in FIG. 4a. With all SCDs 10, 11 and 12 inactive, the outboard flap-outboard vortex 104 is located at the position indicated by outboard flap-outboard vortex location 41 (see FIG. 8a). The outboard flap-inboard vortex 103 is located at the position indicated by outboard flap inboard vortex location 42. The strength of the outboard vortex exceeds the strength of the inboard vortex.

When ISCD 10 is actuated, the outboard flap-inboard vortex 103 moves further inboard from location 42 to location 52 , with respect to the wing 1 (FIG. 8b). Furthermore, the strength of the inboard vortex increases and exceeds the strength of the outboard vortex. In contrast, the location of the outboard vortex does not change significantly (location 41 to 51) and neither does its strength change materially. When the OSCD 11 is actuated there is a similar, but opposite effect (FIG. 8c). Namely, the outboard flap-outboard vortex 104 moves further outboard with respect to the wing 1, once again as discussed with respect to FIGS. 6, 7a 7d. Furthermore, the outboard vortex strengthens further. Consistently, the location of the inboard vortex does not change significantly and neither does its strength change materially. Similarly, experimental data is shown for the activation of all SCDs (FIG. 8d) and the RSCD (FIG. 8e).

A similar method can be used on the other control surfaces, for example the inboard flap 2, aileron 6, flaperon 4 or spoilers 7. The inboard flap 2 offers more flexibility, having more than one element: forward flap element 3a and aft flap element 3b (see FIG. 3). Placing SCDs on the flaps is preferred, because the closer the vortices, the greater their instability, and the more rapid their interaction, linking and mutual destruction.

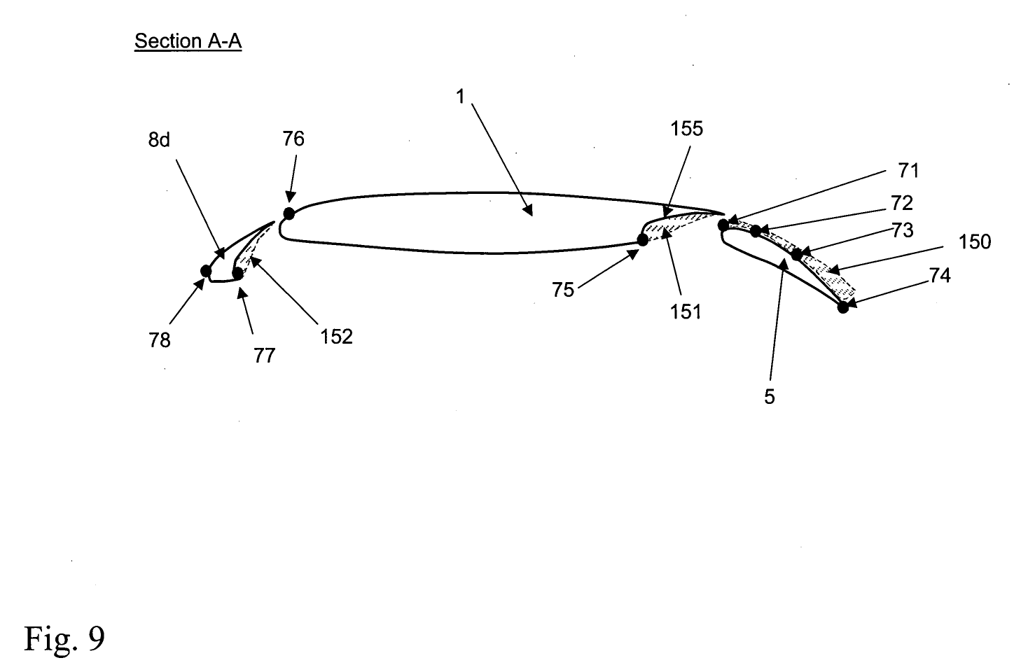

The cross-section A-A indicated in FIG. 3 is shown in FIG. 9 where three regions of separated flow are shown: namely, on the flap 5, indicated by flap separated flow region 150; in the flap-wing cove 155, indicated by separated flow cove region 151; and in the wing leading-edge vicinity, indicated by separated flow leading-edge region 152. The precise placing of SCDs on or within the flap 5 is determined by the vortex management strategy employed (see below). Locations on the flap can be in the vicinity of the flap leading-edge 71; on the fore part of the flap 72; on the aft part of the flap 73; or at the flap trailing edge 74. Locations are only shown with respect to the upper surface, but devices can also be placed on the lower surface. Separation control devices on the flap are preferred, based on the preceding discussion, but separation control devices could also, or otherwise, be placed in the cove or leading-edge regions if more efficient or convenient. As such, SCDs can also be located in the lower surface cove 75, on the main element 76; or at leading-edge device locations 77 and 78. Where separated flow already exists, devices can be used to reduce or further enhance separation. Where no separation exists, devices can only be used to cause separation.

The separation control devices can span the entire high-lift device, e.g. flap, aileron, or flaperon, or may span only a fraction thereof. In addition, the separation control devices need not lie along a line parallel to the device leading or trailing edges, but may be angled (not shown). Flow over the high lift elements, combined with effectiveness of the device placement, dictates location of each SCD. The separation control devices may be passive, such as variously sized vortex generators, or may be actively actuated, as with oscillatory jets or fliperons (which produce small oscillations on the surface that add oscillatory momentum to the flow.) The passive devices may be dynamically deployable, i.e. be deployed and retracted at will. Active devices may also be dynamically deployable in that they are operated intermittently, or their amplitude or frequency is modulated.

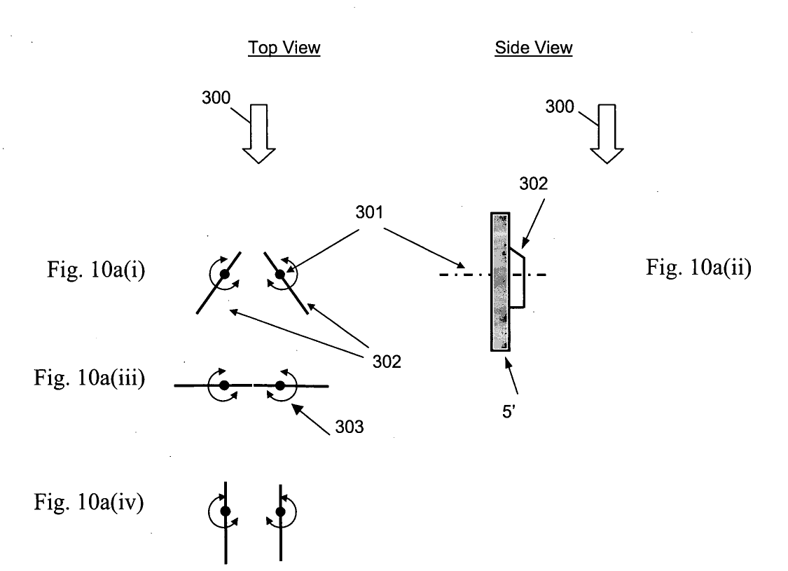

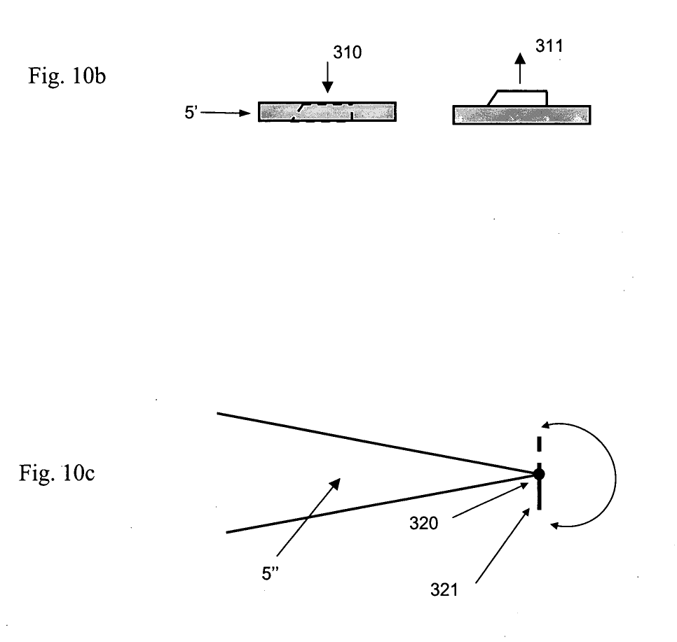

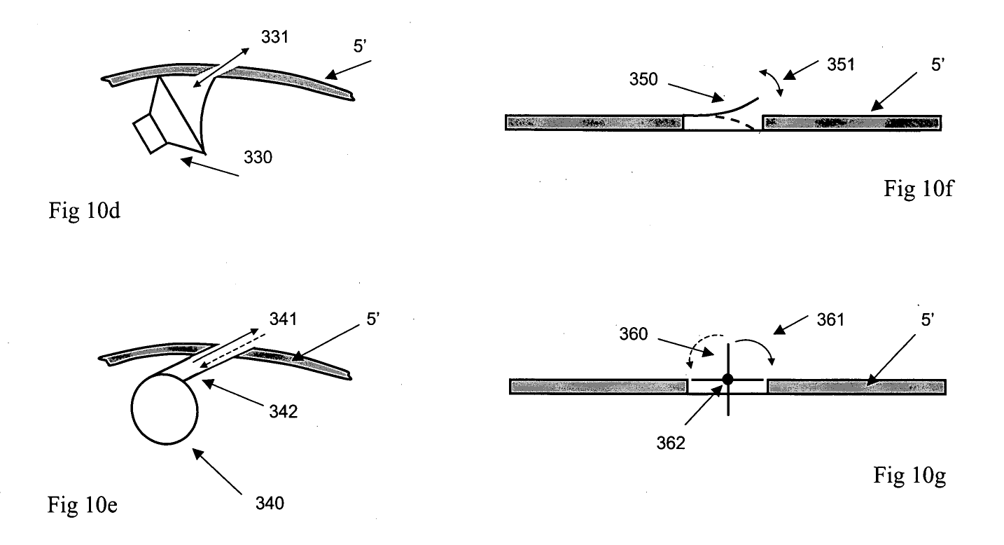

Some examples of enabling separation control devices are shown in FIGS. 10a-10g. FIG. 10a(i) shows a top view of a vortex generator (VG) pair in its standard configuration. FIG. 10a(ii) shows a side view. Typical VGs can be oriented at approximately 45° to the flow in order to achieve maximum reduction in separation, and consequently maximum lift enhancement. As mentioned above, SCDs can be dynamically deployable. This is achieved, for example by mounting the VG pair 302 on a part of the flap 5′ (see FIG. 10(b)) such that it is deployed on axis 301 and is then rotated in the sense of 303 on axis 301 relative to flow direction 300 as shown in FIGS. 10a(iii) and 10a(iv). These VG axes may be driven by servo-motors (not shown), for example. FIG. 10a(iii) shows the VG rotated such that its elements lie perpendicular to the flow direction. In such a case, flow separation is promoted and hence lift is reduced in the vicinity of the fence. Furthermore, the VG can be deployed in a manner that it lies parallel to the flow as shown in FIG. 10a(iv). In such a case the VG elements have no significant net effect on the flow. Clearly, the VG can be deployed at any arbitrary setting depending upon the amount if separation control required. Moreover, the VG elements need not be deployed at the same angle. Finally, it should be noted that VGs come in a variety of different shapes, and some employ only a single VG element.

FIG. 10b shows a similar concept with the exception that the entire VG is in recessed position 310 or fully deployed position 311 from the surface of the flap or wing. This may be achieved by folding or bending the VG using servo-motors, piezo-electric materials, memory alloys (all not shown) etc.

FIG. 10c shows a different type of SCD called a Gurney flap 321, mounted on an axis 320 near the trailing-edge of the flap 5″ or wing. A Gurney flap is usually a short straight flap angled downwards, normal to the surface of the wing. When the flap faces vertically downwards, it acts to increase lift by reducing trailing-edge separation. When oriented vertically upwards, the flap acts to decrease lift by forcing separation. The flap can be dynamically deployable (or variable) by driving it on its axis. It can thus be oriented at any angle, from parallel to the flap/wing lower surface to parallel to the flap/wing upper surface, a range of almost 360°.

Examples of active separation control devices are shown in FIGS. 10d-10g (prior art—see Wygnanski, U.S. Pat. No. 5,209,438). FIG. 10d shows a zero mass-flux blowing device 330 that blows and sucks air through a slot or orifice 331 on the wing surface in an oscillatory manner. This can be achieved by an acoustic device as shown, by piezo devices (not shown), by pistons (not shown), and the like. These devices add momentum to the flow boundary layer adjacent to the wall, thereby improving separation control. It is common for such devices to operate at an excitation frequency fₑ that is determined by the dimensionless frequency:
F⁺=fₑx_{fo}/V (9)
where F⁺ is in the approximate range 0.2 to 5. Here x_{fo} refers to the outboard flap length defined with respect to FIG. 4b, but similar lengths can obviously be defined for the other flap elements, ailerons, flaperons, spoilers, and the like. Separation control can further be achieved by means of blowing or sucking devices 340 (FIG. 10e), where the blowing or sucking 341 can be achieved in a time-invariant manner. Furthermore, an oscillation can be superimposed on the mean blowing or suction. Blowing or sucking device 340 can be an oscillatory blower, a steady blower, a suction device, or a combustion based device. Examples of surface-mounted flapping devices 350 or rotating devices 360 that rotate on an axis 361 are shown in FIGS. 10f and 10g.

The present invention advances two main methods: a time-invariant method and a time-dependent method. The first method applies either passive or active SCDs in a static or time-invariant manner, and then lets the atmospheric or flight unsteadiness perturb the wakes and initiate the instability. The second method involves dynamically deploying either passive or active devices in a time-dependent manner and thereby directly exciting one or more wake instabilities.

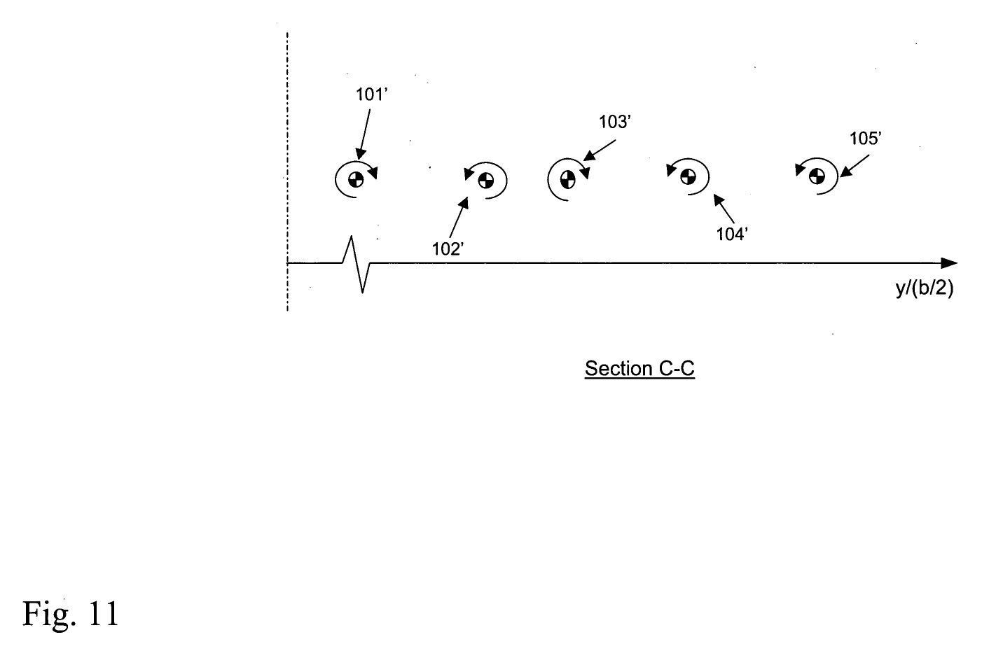

An example of applying a time-invariant method is described by referring back to FIG. 3. For this example, the ISCD 10 on flaps 2 and 5 is deployed to reduce separation, thereby increasing lift and strengthening the both flap-inboard vortices 101 and 103 (see FIG. 2). The OSCD 11, in contrast, is deployed to increase separation, thereby reducing lift and weakening the both flap-outboard vortices. Note that the SCDs can be either passive or active (see FIGS. 10a-10g). The resulting wake signature will be similar to that shown in FIG. 11, and consists of multiple pairs of counter-rotating vortices 101′-105′ of approximately equally strength. Note that a similar signature will exist in the wake of the portside wing. A wake signature of this nature leads to a rapid interaction and mutual destruction of the vortices.

When such passive separation control devices are used, wake alleviation is achieved with very little redesign of the high lift system. Passive separation control devices can simply be retrofitted, resulting in an inexpensive solution to the problem. However, passive devices generally have less control authority than active devices.

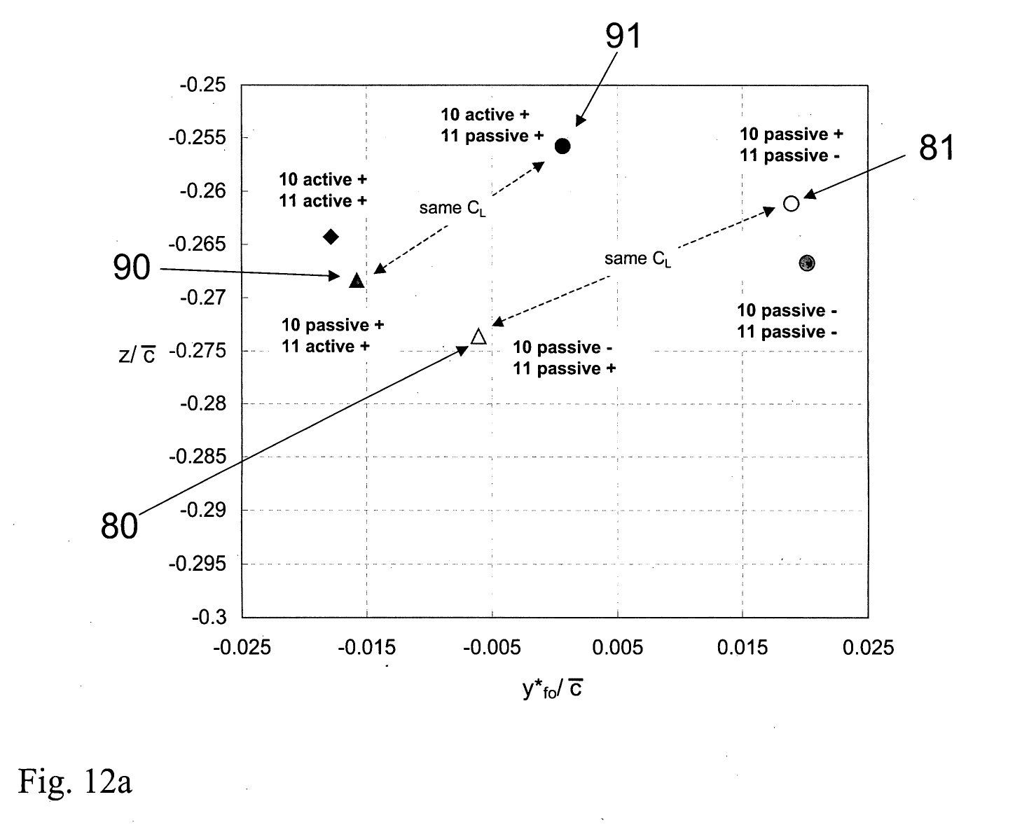

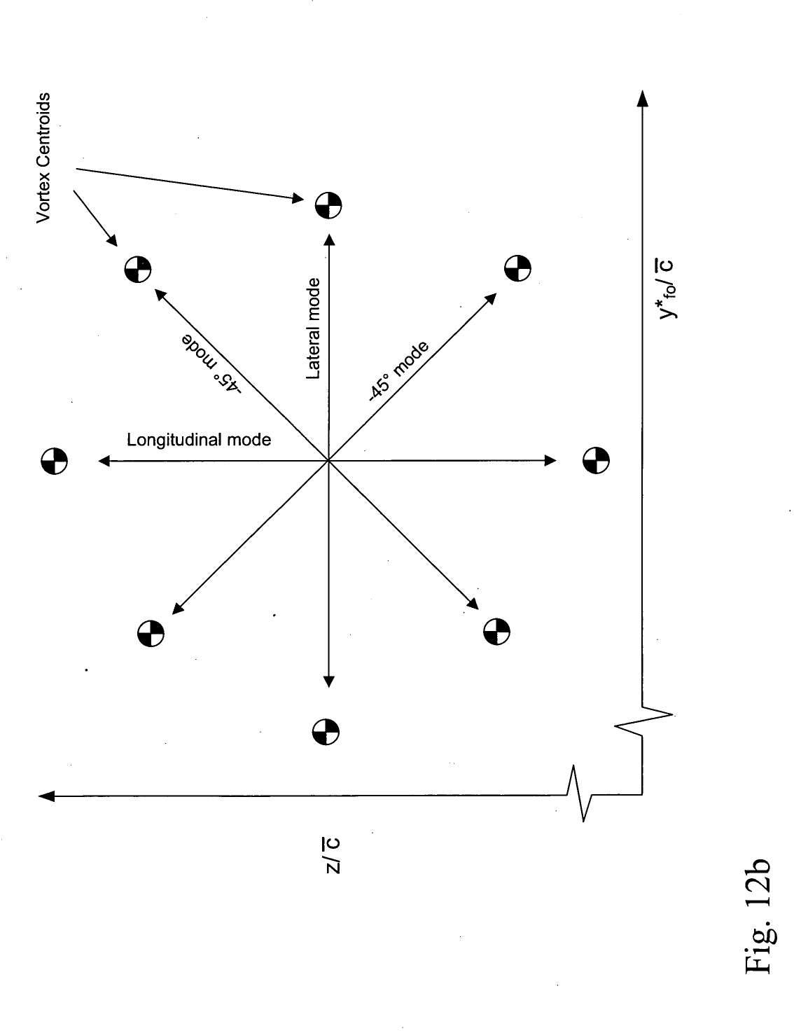

The above discussion relates only to lateral (side-to-side) displacement of the vortices. It should be appreciated, however, that the vortices can be displaced in the longitudinal (up-and-down) direction as well. A summary of experimentally determined vortex locations generated in the wake of the outboard side of outboard flap 5 is shown in FIG. 12a. FIG. 12a shows a map of vortex locations in the y_{fo}*/\overline{c}−z/\overline{c} plane, where y_{fo}* is measured from the outboard side of the flap (FIG. 4a) and z is measured perpendicular to the planform view shown in FIG. 4a. The locations are generated using a combination of passive and active devices deployed at the locations corresponding to 10 and 11 of flap 2. The “+” sign indicates that the SCD is deployed to enhance lift (ameliorate separation); the “−” sign indicates that the SCD is deployed to reduce lift (promote separation). FIG. 12a shows that the combination of devices at different locations allows flexible placement of the vortex location. This can be used to great effect for time-dependent wake alleviation that can be achieved by deploying passive or active separation control devices in a dynamic, or periodic, manner. Recall that active wake alleviation methods directly excite instabilities in the wake. Consequently, different instability modes can be excited, depending on the instability that is being exploited. For example, FIG. 12b shows four possible modes of excitation, namely: a lateral model; a longitudinal mode; a +45° mode; and a −42° mode. Note that the angles “+45°” and “−45°” are shown here by way of example only. Moreover, two or more modes can be excited simultaneously.

As described previously with respect to FIGS. 6, and 7a-7d, the actuation of a separation control device necessarily changes the lift on the wing. In FIG. 12a, two examples are given where SDCs 10 and 11 are deployed differently (i.e. one to enhance lift and one to reduce lift), resulting in the same lift coefficient (C_{L}) on the wing, but with different lift coefficient distributions Cₗ(y) and consequently different vortex locations as shown in FIG. 12a. This is achieved with passive devices alone, as in the case of the vortex locations 80 and 81, or by using a combination of active and passive devices as shown by vortex locations 90 and 91. Clearly, deployment of SCDs on more than one flap can be used to achieve the same result.

The manner in which time-dependent excitation is achieved is to cause the flow to dynamically separate and reattach, by dynamically deploying passive or active separation control devices at a frequency f_{w}=1/T_{w}. If passive devices are employed, they are dynamically deployed at a wake frequency f_{w}. Active devices that operate at a frequency fₑ, on the other hand, must be deployed (or modulated) at the frequency f_{w}. This can be either an amplitude modulation (including intermittent operation) or a frequency modulation.

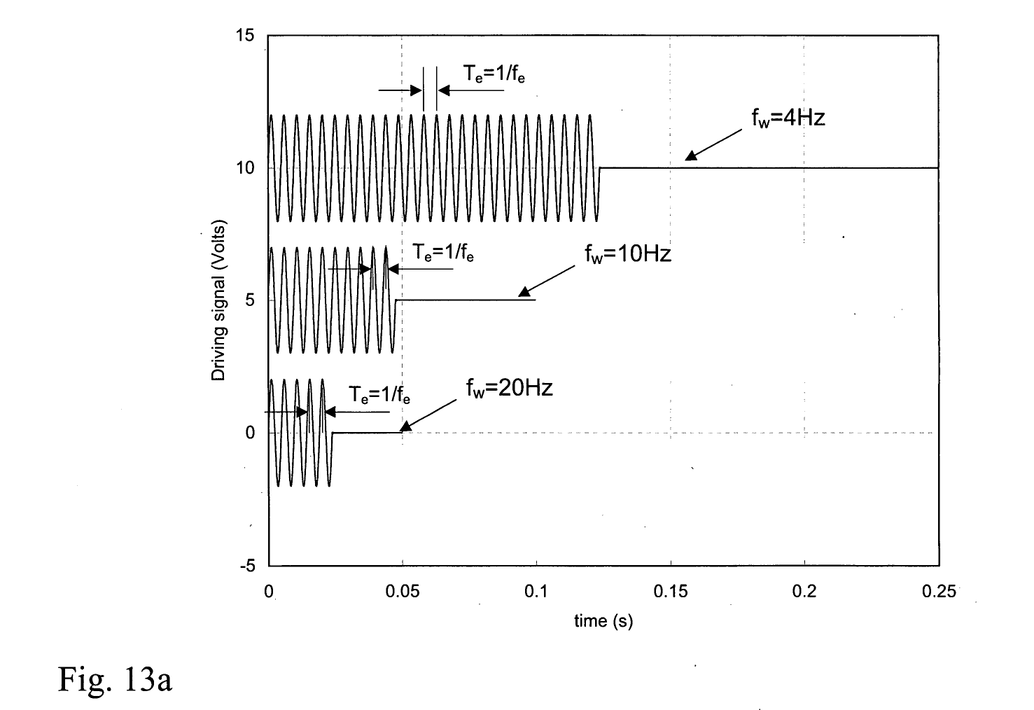

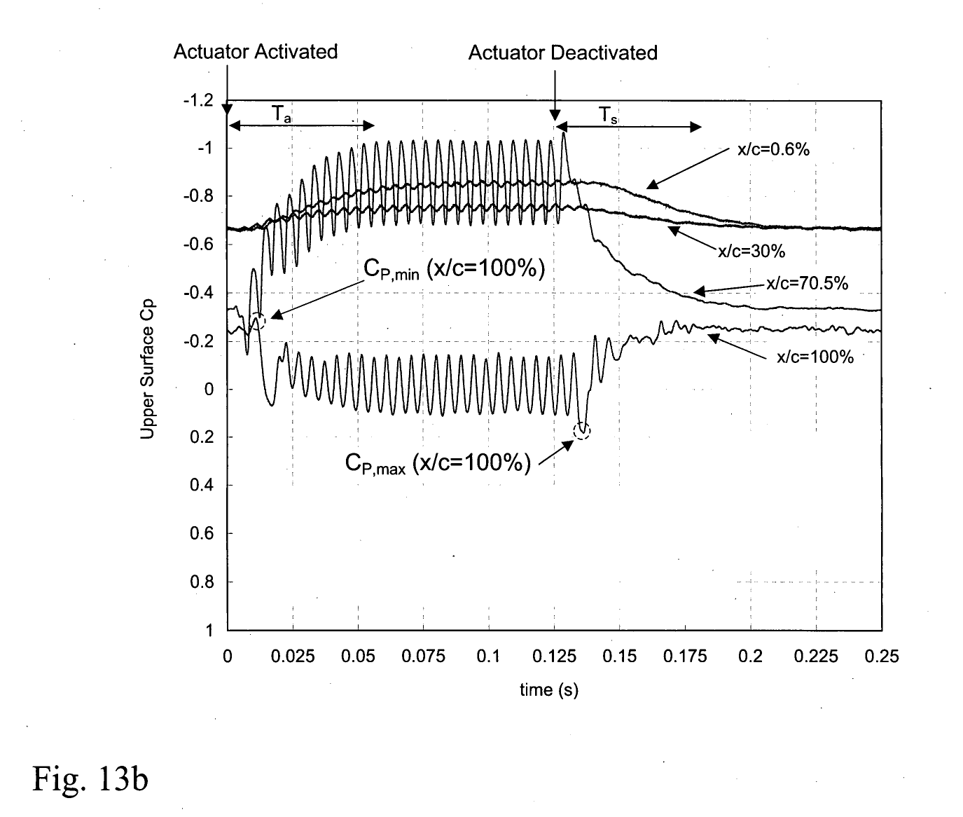

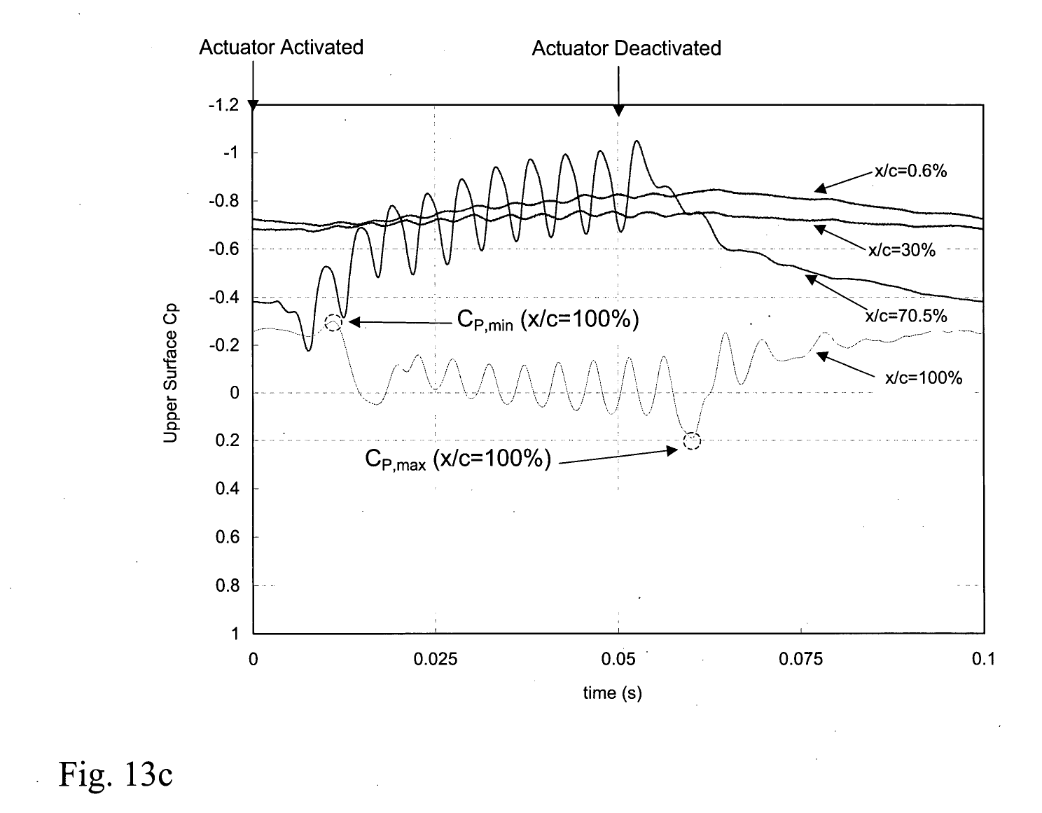

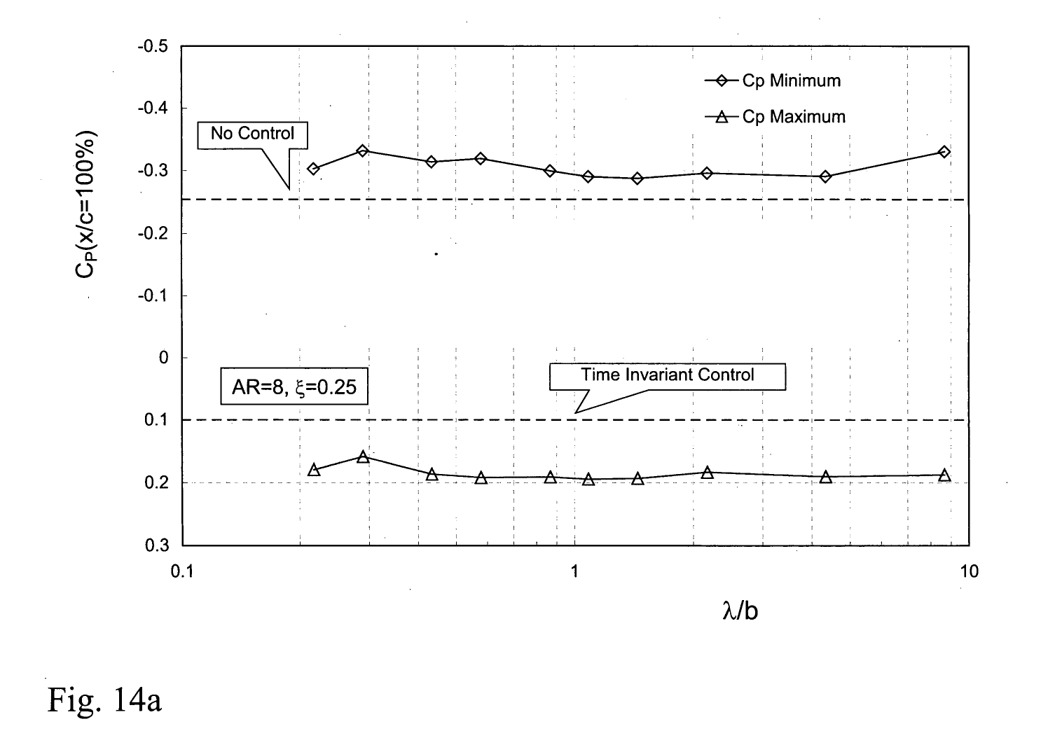

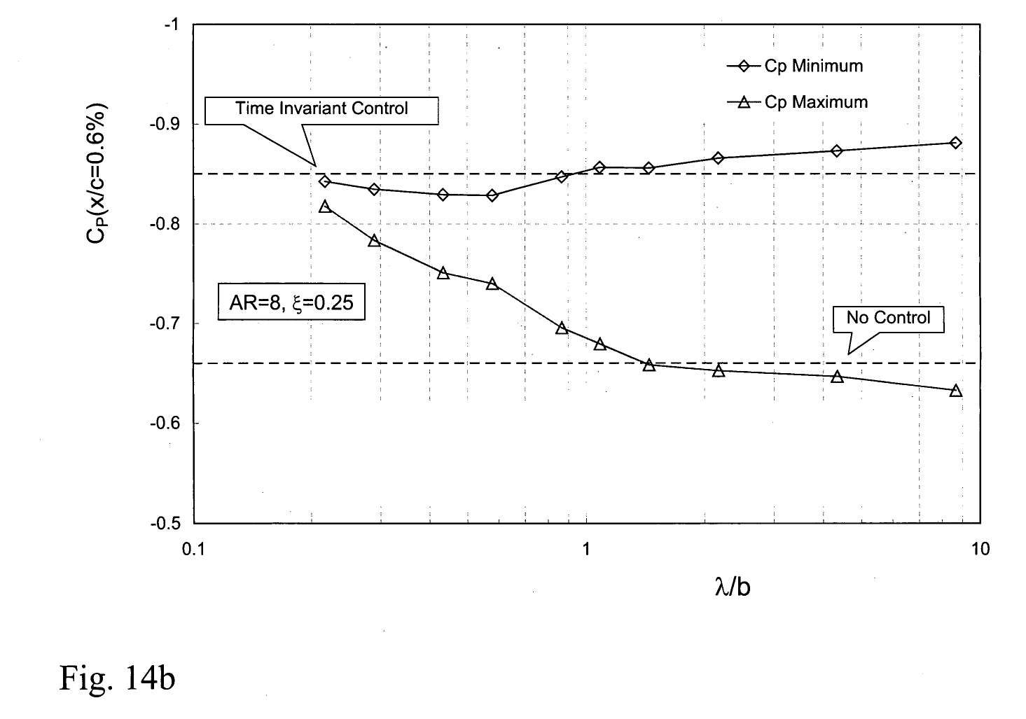

An example of dynamically deploying an active device is described with respect to FIGS. 13a-13c and 14a-14b. FIG. 13a shows the voltage signal that is used to drive an active separation control device, such as that shown in FIG. 10d, at a frequency fₑ (shown on the FIG.). For the case considered, this corresponds to F⁺=0.76 (see equation 9). The device is dynamically deployed by modulating the drive signal in a “burst-mode” (on-off manner) at f_{w}=4 Hz, 10 Hz, and 20 Hz respectively; it is turned on at time=0s and turned-off at a later time. In a similar manner to the definition of F⁺, the dimensionless wake frequency is defined as:
k=f_{w}c_{fo}/V (10)

FIGS. 13b and 13c show the effect of this on the dynamic upper surface pressures on a similar wing, shown here in dimensionless form:
C_{P}=(p−p∞)½ρpV² (11)
for f_{w}=4 Hz and 10 Hz respectively. Dynamic pressures are shown near the wing leading-edge (x/c=0.6%), at x/c=30%, just downstream of the SCD (x/c=70.5%) and at the trailing-edge of the wing (x/c=100%). When the SCD is activated (i.e. turned-on), the wing upper surface pressures respond as the boundary layer attaches to the surface. The approximate time taken for the flow to fully attach to the surface differs depending on the location on the wing, but can be assigned an approximate value Tₐ. When the SCD is deactivated (i.e. turned-off), then similarly the time taken for the flow to fully separate from the surface is different depending on its location on the wing, and is assigned an approximate value Tₛ. Note that Tₛ≅Tₐ, i.e. the time Tₛ taken for flow to dynamically separate from a previously attached state is approximately equal to the time Tₐ taken for flow to dynamically attach from a previously separated state. Therefore, full control authority, i.e. oscillating between fully separated and reattached states, T_{w}, cannot be achieved faster than Tₛ+Tₐ. Consequently, full control authority is achieved for:

$${f}_{w , max} \leq \frac{1}{{T}_{s} + {T}_{a}} \qquad ( 12 )$$

and thus, from equation (10), the maximum dimensionless wake frequency for full control authority is:
kₘₐₓ=f_{w,max}c_{fo}/V (13)
Following convention, λ is denoted as the wake instability wavelength defined as
λ=V/f_{w} (14)
Substituting the definition for ξ_{fo} and equation (10) in (14), and dividing throughout by b results in the expression
λ/b=ξ_{fo}/kAR (15)
and consequently the smallest wavelength for full control authority is:
λₘᵢₙ/b=ξ_{fo}/kₘₐₓAR (16)
It should be noted, however, that arbitrarily long λ/b can be achieved by employing more gradual dynamic deployment of the SCD, such as sinusoidal amplitude or frequency modulation.

Minimum and maximum C_{P} data, taken from figures similar to 13b and 13c, are shown as a function of λ/b for the wing trailing-edge (FIG. 14a) and the leading-edge (FIG. 14b), where typical airline values AR=8 and ξ_{fo}=0.25 are used. When low frequency deployment (f_{w}) is used, corresponding to large λ/b, the dynamic time-dependent control authority at the trailing-edge exceeds the static time-invariant control authority (FIG. 14a). With increasing f_{w}, i.e. decreasing λ/b, the trailing-edge control authority is maintained. Thus, at the trailing-edge where the vortices are shed, the wakes can be excited at least for 0.2<λ/b<9 under the conditions of present example. As mentioned above, arbitrarily large λ/b can be achieved. It should further be appreciated that, on high-lift systems with more than one flap element (e.g. 3aand 3b in FIG. 3), ξ can be smaller and hence λ/b<0.2 can be achieved. Under all circumstances, the preferred mode of operation is such that fₑ≧f_{w}.

The leading-edge minimum and maximum C_{P} data show that the lift oscillations (proportional to C_{P,min}−C_{p,max}) decrease with decreasing λ/b (see FIG. 14b). Furthermore, C_{P,max} tends towards time-invariant control. Thus, the overall lift on the wing increases, but the lift oscillations decrease.

A significant advantage over the prior art is that the control surfaces remain stationary and do not oscillate. For example, if separation control is performed on the flap (as discussed here), or on multiple flaps, then the ailerons are free to control the aircraft. Either the amplitude or the frequency of the separation control devices is dynamically deployed (or modulated) at a frequency that corresponds to the desired wake instability. Thus, the lift distribution on the wing can oscillate between two states while maintaining approximately constant lift, drag and moments. As a consequence, active separation control allows tremendous flexibility in selecting the appropriate method for wake alleviation, and can excite instabilities of wavelength less than or greater than the wing span.

Both the passive and the active methods discussed above can increase the aircraft lift, but this can be balanced by promoting separation. Alternatively, a lift surplus can be offset by either reducing the angle of attack for landing or reducing the flight speed. The addition of lift is in fact an advantage, and thus the present method can only have a beneficial effect on high-lift aerodynamics.

Although the invention has been described relative to several suggested embodiments, there are clearly numerous variations and modifications that will be readily apparent to those skilled in the art, in light of the above teachings. It is therefore to be understood that, within the scope of the appended claims, the invention may be practiced other than as specifically described.

1. A device for managing wake vortices, comprising:
a surface over which a flow passes with a boundary layer between said flow and said surface,
creating a vortex, trailing said surface,
and
a separation control device mounted on said surface.

2. A device for managing wake vortices according to claim 1, wherein the separation control device is active.

3. A device for managing wake vortices according to claim 2, wherein the active separation control device operates in a time-invariant mode.

4. A device for managing wake vortices according to claim 2, wherein the active separation control device operates in a time-dependent mode.

5. A device for managing wake vortices according to claim 4, wherein the time-dependent mode of operation for the active separation control device comprises an excitation frequency, fₑ, and a wake frequency, f_{w}, each having its own magnitude.

6. A device for managing wake vortices according to claim 5, wherein the magnitude of the excitation frequency, fₑ, is at least as great as the magnitude of the wake frequency, f_{w}.

7. A device for managing wake vortices according to claim 1, wherein the separation control device is passive.

8. A device for managing wake vortices according to claim 7, wherein the passive separation control device operates in a time-invariant mode.

9. A device for managing wake vortices according to claim 7, wherein the passive separation control device operates in a time-dependent mode.

10. A device for managing wake vortices according to claim 9, wherein the time-dependent mode of operation for the passive separation control device comprises a preferred frequency corresponding to a preferred wavelength.

11. A method for managing wake vortices trailing a surface over which a flow passes, said flow having a boundary layer, said method comprising the steps of:
manipulating a separation control device to modify said boundary layer to produce a managed separation,
modifying said managed separation to control a vortex sheet strength,
adjusting said controlled vortex sheet strength on the surface to control vortex location,
and
adjusting said controlled vortex location to promote vortex destruction.

12. A method for managing wake vortices according to claim 11, wherein the separation control device is active.

13. A method for managing wake vortices according to claim 12, wherein the active separation control device operates in a time-invariant mode.

14. A method for managing wake vortices according to claim 12, wherein the active separation control device operates in a time-dependent mode.

15. A method for managing wake vortices according to claim 14, wherein the time-dependent mode of operation for the active separation control device comprises an excitation frequency, fₑ, and a wake frequency, f_{w}, each having its own magnitude.

16. A method for managing wake vortices according to claim 15, wherein the magnitude of the excitation frequency, fₑ, is at least as great as the magnitude of the wake frequency, f_{w}.

17. A method for managing wake vortices according to claim 11, wherein the separation control device is passive.

18. A method for managing wake vortices according to claim 17, wherein the passive separation control device operates in a time-invariant mode.

19. A method for managing wake vortices according to claim 17, wherein the passive separation control device operates in a time-dependent mode.

20. A method for managing wake vortices according to claim 19, wherein the time-dependent mode of operation for the passive separation control device comprises a preferred frequency corresponding to a preferred wavelength.

21. A method for managing wake vortices trailing a surface over which a flow passes, said flow having a boundary layer, said method comprising the steps of:
modifying said boundary layer by manipulation of a separation control device,
monitoring change, resulting from said modifying of boundary layer separation, of at least one property of at least one of said vortices; said property selected from the group consisting of vortex strength, vortex size, vortex location, and vortex velocity,
further modifying said boundary layer separation by manipulation of a separation control device, such that at least one or more of said properties is further changed in a way conducive to destruction of at least one vortex.

22. A method for managing wake vortices according to claim 21, wherein the separation control device is active.

23. A method for managing wake vortices according to claim 22, wherein the active separation control device operates in a time-invariant mode.

24. A method for managing wake vortices according to claim 22, wherein the active separation control device operates in a time-dependent mode.

25. A method for managing wake vortices according to claim 24, wherein the time-dependent mode of operation for the active separation control device comprises an excitation frequency, fₑ, and a wake frequency, f_{w}, each having its own magnitude.

26. A method for managing wake vortices according to claim 25, wherein the magnitude of the excitation frequency, fₑ, is at least as great as the magnitude of the wake frequency, f_{w}.

27. A method for managing wake vortices according to claim 21, wherein the separation control device is passive.

28. A method for managing wake vortices according to claim 27, wherein the passive separation control device operates in a time-invariant mode.

29. A method for managing wake vortices according to claim 27, wherein the passive separation control device operates in a time-dependent mode.

30. A method for managing wake vortices according to claim 29, wherein the time-dependent mode of operation for the passive separation control device comprises a preferred frequency corresponding to a preferred wavelength.

31. A method for managing trailing vortices of an aircraft having one or more control surfaces over which a flow passes, said flow having a degree of flow separation, the method comprising the steps of:
deploying a separation control device on said one or more control surfaces,
adjusting said deployment of said separation control devices to vary the degree of flow separation on said one or more control surfaces,
causing said varying of said degree of flow separation to cause a varying of vortex sheet strength,
causing said varying of vortex sheet strength to modify at least one property of at least one of said vortices, said property selected from the group consisting of vortex strength, vortex size, vortex location, and vortex velocity,
and
further causing said varying of said degree of flow separation to cause a varying of vortex sheet strength, such that at least one or more of said properties is further changed in a way conducive to destruction of at least one vortex.

32. A method for managing wake vortices according to claim 31, wherein the separation control device is active.

33. A method for managing wake vortices according to claim 32, wherein the active separation control device operates in a time-invariant mode.

34. A method for managing wake vortices according to claim 32, wherein the active separation control device operates in a time-dependent mode.

35. A method for managing wake vortices according to claim 34, wherein the time-dependent mode of operation for the active separation control device comprises an excitation frequency, fₑ, and a wake frequency, f_{w}, each having its own magnitude.

36. A method for managing wake vortices according to claim 35, wherein the magnitude of the excitation frequency, fₑ, is at least as great as the magnitude of the wake frequency, f_{w}.

37. A method for managing wake vortices according to claim 31, wherein the separation control device is passive.

38. A method for managing wake vortices according to claim 37, wherein the passive separation control device operates in a time-invariant mode.

39. A method for managing wake vortices according to claim 37, wherein the passive separation control device operates in a time-dependent mode.

40. A method for managing wake vortices according to claim 39, wherein the time-dependent mode of operation for the passive separation control device comprises a preferred frequency corresponding to a preferred wavelength.
